(19) United States
(12) Patent Application Publication
(10) Pub. No.: US 2016/0034859 A1
(43) Pub. Date: Feb. 4, 2016

(54) SYSTEM AND METHOD FOR CASHLESS TRANSACTIONS

(71) Applicant: UBONA TECHNOLOGIES PVT LTD, Bangalore (IN)

(72) Inventors: ANSHUMAN PUROSHOTTAM, BANGALORE (IN); MANAS KUMAR MALLIK, BANGALORE (IN); VIVEK SRIVASTAVA, BANGALORE (IN); ABHIJIT GAIROLA, BANGALORE (IN)

(21) Appl. No.: 14/539,025

(22) Filed: Nov. 12, 2014

(30) Foreign Application Priority Data
Aug. 4, 2014 (IN) 3818/CHE/2014

(51) Int. Cl. G06Q 20/06; G06Q 20/32; G06Q 20/20; G06Q 20/38

(52) U.S. Cl. CPC G06Q 20/065; G06Q 20/3829; G06Q 20/327; G06Q 20/202; G06Q 20/385; G06Q 2220/00

(57) ABSTRACT

The present invention provides a method for cashless transaction at a point of sale. The method includes receiving unique information from a payment infrastructure corresponding to user. The unique information is received upon the user sending a request to the payment infrastructure. In addition, the method includes creating a data packet by a mobile device corresponding to the user. The data packet comprises an amount to be paid, the unique information, identity of the mobile device corresponding to the user a transaction number. The amount is entered by the user, wherein the data packet is encrypted. In addition, the method includes sending the data packet to a mobile device corresponding to a merchant. In addition, the method includes receiving an encrypted data from the merchant. In addition, the method includes sending information to the payment infrastructure, wherein the information comprises the decryption of the encrypted data received from the merchant.

### RELATED APPLICATIONS

This application claims the benefit and priority to Indian Application Serial No. 3818/CHE/2014 entitled “SYSTEM AND METHOD FOR CASHLESS TRANSACTIONS,” filed on Aug. 4, 2014, the contents of which are hereby incorporated by reference.

### FIELD OF THE INVENTION

The present invention relates to cashless transactions. In particular, the invention relates to cashless transactions at a point of sale.

### BACKGROUND

With the advent of mobile technology, digital currencies have gained favour among customers and merchants alike. Digital currencies are a medium of electronic transaction for the purchase of various goods and services. Example of digital currencies includes Bitcoin. However, there are various disadvantages to the use of digital currencies. Many digital currencies have not yet seen widespread usage, and may not be easily used or exchanged. Banks generally do not accept or offer services for such digital currencies.

US20040083168 A1 describes a payment system for cashless payment transactions in trade. A customer uses his mobile phone or pager to prompt payment of the purchase sum from a creditor to a vendor. The creditor transmits to the customer's mobile phone a TAN. The TAN is transmitted by means of a mobile phone interface to a payment console belonging to the vendor. The TAN is then transmitted, preferably via a fixed line, to the creditor. The creditor immediately posts the payment sum for the vendor and informs the parties involved as appropriate. However, the transmission of the TAN is not encrypted. Furthermore, the merchant does not verify the amount paid by the user.

US20080103982 describes a method for cashless transactions. The method includes generating at an access device an initial key. Further, the method includes sending the initial key to a key storage location. In addition, the method includes altering the initial key with a public key to form an altered key. Moreover, the method includes sending the altered key from the access device to a server computer along with an identifier for the access device. Furthermore, the method includes altering, with the initial key that is stored at the key storage location, transaction data associated with a plurality of financial transactions that are conducted using the access device. However, the transmission of the key is not encrypted. Furthermore, the merchant does not verify the amount paid by the user.

U.S. Pat. No. 8,386,349 describes A method of processing a transaction. The processing method includes receiving data from a portable consumer device at a reader. In addition, the method includes processing the supplemental verification value at the reader. Furthermore, the method includes authorizing the transaction if the processing of the supplemental verification value indicates that the portable consumer device is authenticated. However, the transmission of the data is not encrypted. Furthermore, the merchant does not verify the amount paid by the user.

In light of the above discussion, there is a need for a method and a system for cashless transactions at a point of sale.

### SUMMARY

The present invention provides a method for cashless transaction at a point of sale, the method includes receiving unique information from a payment infrastructure corresponding to user. The unique information is received upon the user sending a request to the payment infrastructure. In addition, the method includes creating a data packet by a mobile device corresponding to the user. The data packet includes an amount to be paid, the unique information, an identity of the mobile device corresponding to the user, a transaction number, wherein the amount is entered by the user, wherein the data packet is encrypted. In addition, the method includes sending the data packet to a mobile device corresponding to a merchant. In addition, the method includes receiving an encrypted data from the merchant. In addition, the method includes sending information to the payment infrastructure, wherein the information comprises the decryption of the encrypted data received from the merchant.

In an aspect, the invention verifies the amount by the merchant. Further, the method includes, adding merchant information. The merchant information includes an identity of the mobile device corresponding to the merchant. In addition, the method includes, sending the data to a backend server. In addition, the method includes, decrypting the received data. In addition, the method includes, notifying the merchant and the user upon completion of the transaction. In an aspect, the unique information corresponding to the user is a onetime password. In another aspect, the encrypted data packet is sent using acoustic audio transmission.

In yet another aspect, the invention provides a system for cashless transaction at a point of sale, the system includes a receiver configured to receive unique information from a payment infrastructure corresponding to user. The unique information is received upon the user sending a request to the payment infrastructure. The receiver is also configured to receive encrypted data from the merchant. Further, the system includes a data packet module configured to create a data packet by a mobile device corresponding to the user. The data packet comprises an amount to be paid, the unique information, an identity of the mobile device corresponding to the user, a transaction number. The amount is entered by the user, wherein the data packet is encrypted. In addition, the system includes a transmitter configured to send the data packet to a mobile device corresponding to a merchant. The transmitter is also configured to send information to the payment infrastructure. The information comprises the decryption of the encrypted data received from the merchant.

In another aspect, the system includes a verification module configured to verify the amount at the merchant end. In another aspect, the system includes an addition module configured to add merchant information. The merchant information includes an identity of the mobile device corresponding to the merchant. In another aspect, the transmitter is configured to send the data to a backend server. In yet another aspect, the system includes a decryption module configured to decrypt the received data. In yet another aspect, the system includes a notification module configured to notify the merchant and the user upon completion of the transaction. In yet another aspect, the unique information is a onetime password. In yet another aspect, the encrypted data packet is sent using acoustic audio transmission.

### BRIEF DESCRIPTION OF THE DRAWINGS

FIG. 1 illustrates a system for cashless transaction at a point of sale, in accordance with embodiments of the present invention;

FIG. 2 illustrates a block diagram of an authentication server for cashless transaction at a point of sale, in accordance with embodiments of the present invention; and

FIG. 3 illustrates a flowchart for cashless transaction at a point of sale, in accordance with embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

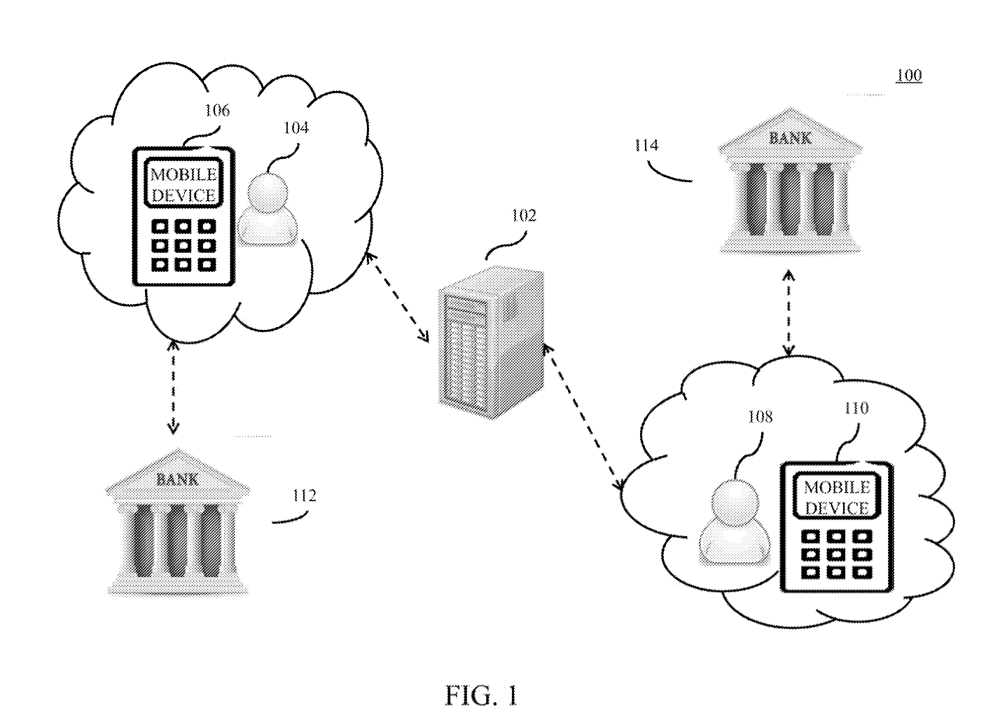

FIG. 1 illustrates a system 100 for cashless transaction at a point of sale, in accordance with embodiments of the present invention. A user 104 interacts with an authentication server 102 to perform a transaction. In an embodiment, the user 104 interacts with the authentication server 102 to initiate a payment for a service purchased by the user 104. In another embodiment, the user 104 interacts with the authentication server 102 to initiate a payment for a product purchased by the user 104. The user 104 interacts with the authentication server 102 using a mobile device 106 associated with the user 104. The user 104 interacts with a bank 112 to complete the payment process. The bank 112 provides information to the user 104 in order to authenticate the user 104.

A merchant 108 interacts with the authentication server 102 to perform a transaction using a mobile device 110 associated with the merchant 108. In an embodiment, the merchant 108 initiates a payment reception process for a service sold to the user 104. In another embodiment, the merchant 108 interacts with the authentication server 102 to initiate a payment reception for a product sold to the user 104. The merchant 108 interacts with a bank 114 to complete the payment reception process. The bank 114 provides information to the merchant 108 in order to authenticate the merchant 108.

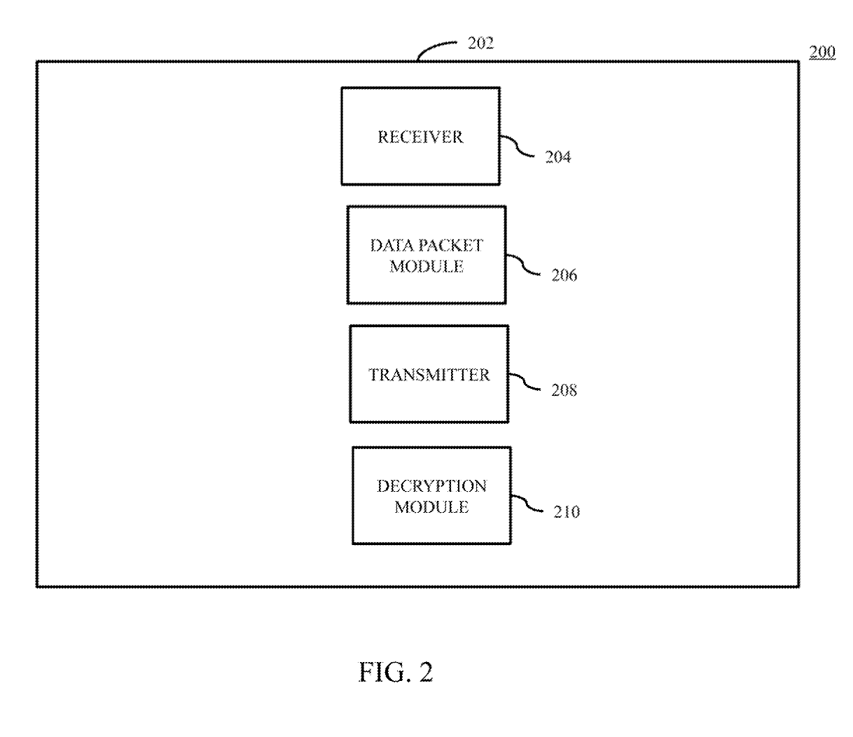

FIG. 2 illustrates a block diagram 200 of an authentication server 202 for cashless transaction at a point of sale, in accordance with embodiments of the present invention. The functions and capabilities of the authentication system 202 is the same as the functions and capabilities of the authentication system 102. The authentication system 202 includes a receiver 204. The receiver 204 is configured to receive unique information associated with the user 104 from a payment infrastructure. In an embodiment, the unique information received is a security token. In another embodiment, the unique information received is a onetime password (hereinafter referred to as OTP). In an embodiment, the OTP is a time synchronized OTP. In another embodiment, the OTP is generated by a mathematical algorithm. The receiver 204 is further configured to receive encrypted data form a merchant 108. The encrypted data includes mobile device identity number of a mobile device associated with the merchant 108. In an embodiment, the encrypted data includes a merchant identity number associated with the merchant 108.

The authentication system 202 includes a data packet module 206. The data packet module 206 is configured to create a data packet corresponding to the user 104. In an embodiment, the data packet includes an amount to be paid, the unique information associated with the user 104, an identity of the mobile device associated with the user 104 and a transaction number corresponding to the initiated transaction. The data packet module 206 is configured to encrypt the created data packet. The algorithm used for encryption of the data packet includes, but is not limited to private key encryption, public key encryption, advanced encryption standard, digital encryption standard and the like.

The authentication system 202 includes a transmitter 208. The transmitter 208 is configured to send the data packet to the mobile device 110 associated with the merchant 108. In an embodiment, the data packet is sent to the mobile device 110 associated to the merchant 108 using acoustic audio transmission. Examples of modulation techniques used for transmitting the data packet using acoustic audio transmission include, but are not limited to amplitude modulation, double-sideband modulation, single-sideband modulation, vestigial sideband modulation, quadrature amplitude modulation, frequency modulation, pulse modulation and the like. In an embodiment, the modulation technique includes converting the data packet into one or more binary sequences using a binary encoding scheme. In this embodiment, the modulation technique further includes selecting one or more sets of frequencies from a frequency matrix based on the one or more binary sequences. Further, the modulation technique further includes pre-pending a starter frequency to the one or more sets of frequencies. Furthermore the modulation technique further includes generating one or more audio signals based on the one or more sets of frequencies. In addition, the modulation technique includes generating an acoustic output based on the one or more audio signals.

The transmitter 208 is further configured to send information to the payment infrastructure. The information includes the decryption of the encrypted data received from the merchant 108. The authentication system 202 includes a decryption module 210. The decryption module 210 is configured to decrypt the encrypted data received from the merchant 108.

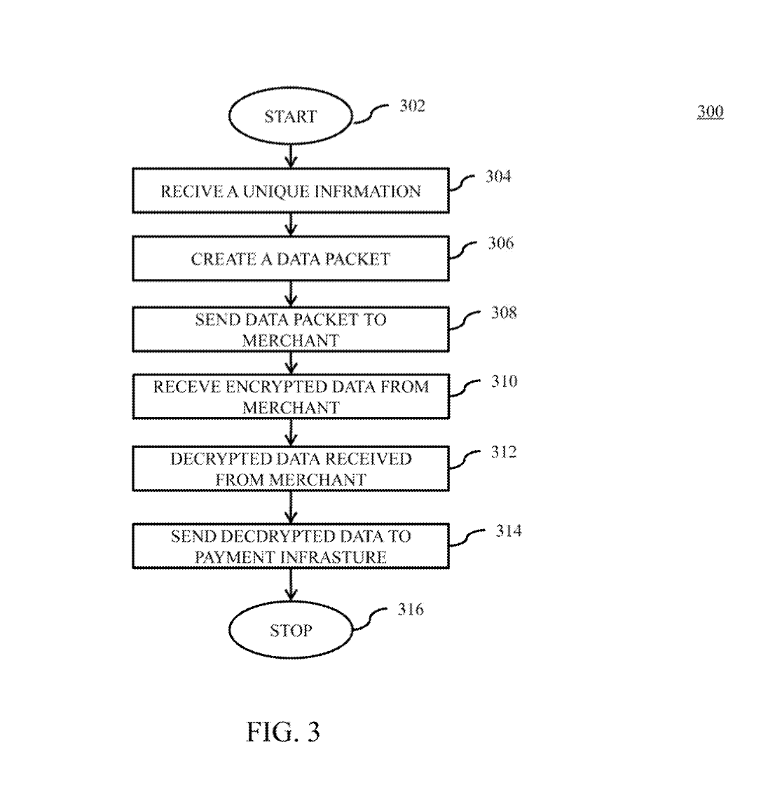

FIG. 3 illustrates a flowchart 300 for cashless transaction at a point of sale, in accordance with embodiments of the present invention. The flowchart 300 initiates at step 302. At step 304, the receiver 204 receives unique information associated with the user 104 from a payment infrastructure. In an embodiment, the unique information received is a security token. In another embodiment, the unique information received is a onetime password (hereinafter referred to as OTP). In an embodiment, the OTP is a time synchronized OTP. In another embodiment, the OTP is generated by a mathematical algorithm.

At step 306, the data packet module 206 creates a data packet corresponding to the user 104. In an embodiment, the data packet includes an amount to be paid, the unique information associated with the user 104, an identity of the mobile device associated with the user 104 and a transaction number corresponding to the initiated transaction. The data packet is encrypted using an encryption algorithm. The algorithm used for encryption of the data packet includes, but is not limited to private key encryption, public key encryption, advanced encryption standard, digital encryption standard and the like.

At step 308, the transmitter 208 sends the encrypted data packet to mobile device 110 associated with the merchant 108. In an embodiment, the data packet is sent to the mobile device 110 associated to the merchant 108 using acoustic audio transmission. Examples of modulation techniques used for transmitting the data packet using acoustic audio transmission include, but are not limited to amplitude modulation, double-sideband modulation, single-sideband modulation, vestigial sideband modulation, quadrature amplitude modulation, frequency modulation, pulse modulation and the like.

At step 310, the receiver 204 receives an encrypted data packet from the mobile device 110 associated with the merchant 108. The encrypted data includes mobile device identity number of the mobile device 110 associated with the merchant 108. In an embodiment, the encrypted data includes a merchant identity number associated with the merchant 108.

At step 312, the decryption module 210 decrypts the encrypted data received from the mobile device 110 associated with the merchant 110. At step 314, the transmitter 208 sends the decrypted data to a payment infrastructure. The flow chart terminates at step 316.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for cashless transaction at a point of sale, the method comprising:
a. receiving unique information from a payment infrastructure corresponding to user, wherein the unique information is received upon the user sending a request to the payment infrastructure;
b. creating a data packet by a mobile device corresponding to the user, wherein the data packet comprises an amount to be paid, the unique information, an identity of the mobile device corresponding to the user, a transaction number, wherein the amount is entered by the user, wherein the data packet is encrypted;
c. sending the data packet to a mobile device corresponding to a merchant;
d. receiving an encrypted data from the merchant; and
e. sending information to the payment infrastructure, wherein the information comprises the decryption of the encrypted data received from the merchant.

2. The method as claimed in claim 1, further comprising, verifying the amount by the merchant.

3. The method as claimed in claim 1, further comprising, adding merchant information, wherein the merchant information includes an identity of the mobile device corresponding the merchant,

4. The method as claimed in claim 1, further comprising, decrypting the received data

5. The method as claimed in claim 1, further comprising, notifying the merchant and the user upon completion of the transaction.

6. The method as claimed in claim 1, wherein the unique information is a onetime password.

7. The method as claimed in claim 1, wherein the encrypted data packet is sent using acoustic audio transmission.

8. The method as claimed in claim 1, wherein the modulation technique includes:
converting the data into one or more binary sequences using a binary encoding scheme;
a. selecting one or more sets of frequencies from a frequency matrix based on the one or more binary sequences;
b. pre-pending a starter frequency to the one or more sets of frequencies;
c. generating one or more audio signals based on the one or more sets of frequencies; and
d. generating an acoustic output based on the one or more audio signals.

9. A system for cashless transaction at a point of sale, the system comprising:
a. a receiver configured to
i. receive unique information from a payment infrastructure corresponding to user, wherein the unique information is received upon the user sending a request to the payment infrastructure; and
ii. receiving encrypted data from the merchant;
b. a data packet module configured to create a data packet by a mobile device corresponding to the user, wherein the data packet comprises an amount to be paid, the unique information, an identity of the mobile device corresponding to the user, a transaction number, wherein the amount is entered by the user, wherein the data packet is encrypted; and
c. a transmitter configured to
i. send the data packet to a mobile device corresponding to a merchant; and
ii. send information to the payment infrastructure, wherein the information comprises the decryption of the encrypted data received from the merchant.

10. The system as claimed in claim 9, further comprising a verification module configured to verify the amount at the merchant end.

11. The system as claimed in claim 9, further comprising an addition module configured to add merchant information, wherein the merchant information includes an identity of the mobile device corresponding the merchant,

12. The system as claimed in claim 9, further comprising a decryption module configured to decrypt the received data.

13. The system as claimed in claim 9, further comprising a notification module configured to notify the merchant and the user upon completion of the transaction.

14. The system as claimed in claim 9, wherein the encrypted data packet is sent using acoustic audio transmission.

15. The system as claimed in claim 9, further comprising an acoustic modulation module including:
a. an encoder, wherein the encoder is configured to
i. convert the data into one or more binary sequences using a binary encoding scheme;
ii. select one or more sets of frequencies from a frequency matrix based on the one or more binary sequences; and
iii. prepend a starter frequency to the one or more sets of frequencies;
b. an audio generator for generating one or more audio signals based on the one or more sets of frequencies;
c. a storage module, wherein the storage module comprises
i. the frequency matrix having a plurality of frequencies; and
d. an output module, wherein the output module includes one or more an electro acoustic transducers for generating an acoustic output based on the one or more audio signals.
